(19) United States
(12) Patent Application Publication
(10) Pub. No.: US 2013/0306413 A1
(43) Pub. Date: Nov. 21, 2013

(54) DOUBLE ACTING FLUID CYLINDER LOCK

(71) Applicant: SUSPA GMBH, Altdorf (DE)

(72) Inventors: Glen Robert Wilkinson, Paw Paw, MI (US); Kevin Thomas Braat, Portage, MI (US)

(73) Assignee: Suspa GmbH, Altdorf (DE)

(21) Appl. No.: 13/774,460

(22) Filed: Feb. 22, 2013

Related U.S. Application Data
(60) Provisional application No. 61/647,566, filed on May 16, 2012.
(60) Provisional application No. 61/672,920, filed on Jul. 18, 2012.
(60) Provisional application No. 61/758,997, filed on Jan. 31, 2013.
(60) Provisional application No. 61/647,571, filed on May 16, 2012.
(60) Provisional application No. 61/672,925, filed on Jul. 18, 2012.

(51) Int. Cl. F16B 7/14

(52) U.S. Cl. CPC F16B 7/1418
USPC 188/67

(57) ABSTRACT

A brake for a gas spring rod includes a lock base having an axially extending central aperture and a pair of associated conical surfaces surrounding the aperture. It also includes a pair of clamping members positioned on opposite sides of the lock base, each of the members including a center aperture and a conical surface having an axis offset from the axis of said center aperture. The clamping members are coupled to the lock base by a coupling including a bias spring for moving the clamping members into engagement with the lock base with the respective conical surfaces in contact such that the center apertures are offset from said central aperture of said lock base.

### CROSS-REFERENCE TO RELATED APPLICATIONS

This application claims priority under 35 U.S.C. §119(e) and the benefit of U.S. Provisional Application No. 61/647,571 entitled SAFETY RELEASE filed May 16, 2012, by Wilkinson et al.; U.S. Provisional Application No. 61/672,925 entitled SAFETY RELEASE filed Jul. 18, 2012, by Wilkinson et al.; U.S. Provisional Application No. 61/647,566 entitled DOUBLE ACTING FLUID CYLINDER LOCK filed May 16, 2012, by Wilkinson et al.; U.S. Provisional Application No. 61/672,920 entitled DOUBLE ACTING FLUID CYLINDER LOCK filed on Jul. 18, 2012, by Wilkinson et al.; and U.S. Provisional Application No. 61/758,997 entitled SELF-ALIGNING AXIAL BEARING, filed on Jan. 31, 2013, by Wilkinson et al., the entire disclosures of which are incorporated herein by reference.

### BACKGROUND OF THE INVENTION

The present invention relates to a double acting lock for fluid cylinders and particularly gas cylinders employed for raising and lowering adjustable tables.

Use of pressurized gas cylinders frequently referred to as gas springs is commonplace in the furniture industry in which chairs and table heights are desired to be easily adjusted. Typically, the gas spring force is selected to counterbalance the normal weight load expected and its stroke selected for the desired amount of movement. To control the telescopic support tubes in which the gas spring is employed, a variety of locking mechanisms have been employed, as well as controlling the flow of fluid on either side of the piston of a gas spring. Some of the mechanisms employed for locking an adjustable table in place require relatively complicated mechanisms which are both expensive and somewhat prone to failure. There exists a need, therefore, for a relatively robust system which minimizes the number of components to reduce costs and yet provides positive locking of an extendable rod of a gas cylinder in a selected extended or retracted direction.

### SUMMARY OF THE INVENTION

A brake for a gas spring rod includes a lock base having an axially extending central aperture and a pair of conical cam plates with outwardly projecting opposed conical surfaces also having apertures surrounding and aligned with the central aperture of the lock base. It also includes a pair of clamping members positioned on opposite sides of the plates, each of the members including a center aperture and a conical surface having an axis offset from the axis of said apertures of said plates and lock base. The clamping members are coupled to the lock base by a coupling for moving the clamping members into engagement with the lock base and the respective conical surfaces in contact such that the center apertures are offset from said apertures of said plates. In a preferred embodiment the coupling includes a pivot pin extending from the lock base and a pivot lever pivotally coupled to the pivot phi and having opposite ends coupled to the clamping members such that, as the pivot lever is rotated, the clamping members synchronously move toward or away from the lock base. Also in a preferred embodiment a bias spring is coupled between the clamping members to urge them into contact with the plates and lock base. When mounted to an extendable rod of a gas spring by mounting the lock base to one of the telescopic tubes of an adjustable member, the axially offset releasable clamping members, when in a locked position, engage the rod to hold it in a fixed position, thereby holding the telescopic tubes in a selected position.

These and other features, objects and advantages of the present invention will become apparent upon reading the following description thereof together with reference to the accompanying drawings.

### BRIEF DESCRIPTION OF THE DRAWINGS

FIG. 1 is a perspective view of two adjustable tables incorporating the system of the present invention;

FIG. 2 is a side elevational view of a telescopic leg of the table supports shown in FIG. 1;

FIG. 3 is a vertical cross-sectional view of an adjustable table support embodying the locking mechanism of the present invention;

FIG. 4 is an enlarged fragmentary cross-sectional view of the locking mechanism shown in FIG. 3;

FIG. 5 is a fragmentary cross-sectional view, partly cutaway, of the locking mechanism and inner and outer tubes seen in FIG. 4;

FIG. 6 is a perspective view of the locking mechanism, shown removed from the telescopic tubes;

FIG. 7 is an enlarged perspective view of the lock base;

FIG. 8 is a top plan view of the lock base;

FIG. 9 is a right-side elevational view of the base shown in FIG. 8;

FIG. 10 is a fragmentary perspective view of the area X of FIG. 8;

FIG. 11 is a perspective view of one of the identical conical plates;

FIG. 12 is a top view of the plate shown in FIG. 11;

FIG. 13 is a front elevational view of the plate shown in FIGS. 11 and 12;

FIG. 14 is an enlarged perspective view of one of the identical clamping members;

FIG. 15 is a bottom plan view of the clamping member shown in FIG. 14;

FIG. 16 is a rear elevational view of the clamping member shown in FIG. 15;

FIG. 17 is a vertical cross-sectional view of the clamping member taken along section lines XVII-XVII of FIG. 15;

FIG. 18 is a detailed view of the circled area in FIG. 15;

FIG. 19 is a perspective view of one of the pivoted locking levers;

FIG. 20 is a side elevational view of the lever shown in FIG. 19;

FIG. 21 is a top plan view of the lever shown in FIG. 20;

FIG. 22 is a cross-sectional view taken along section lines XXII-XXII of FIG. 20;

FIG. 23 is a side elevational view of one of the springs employed in the locking assembly;

FIG. 24 is a right-side elevational view of the spring shown in FIG. 23;

FIG. 25 is a top plan view of one of the clamping members showing the offset between the axis of the center aperture and the axis of the conical surface;

FIG. 26 is a fragmentary perspective view showing the lock base positioned on the end of the inner telescopic tube; and

FIG. 27 is a fragmentary perspective view showing a clamping member resting on the upper conical cam plate and on the lock base as positioned in FIG. 26.

### DETAILED DESCRIPTION OF THE PREFERRED EMBODIMENT

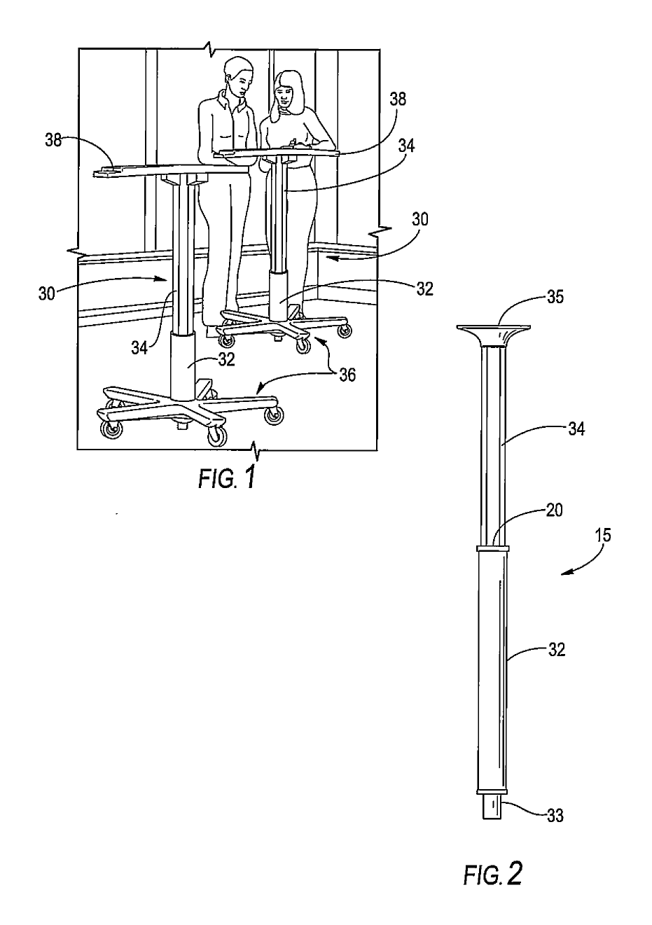

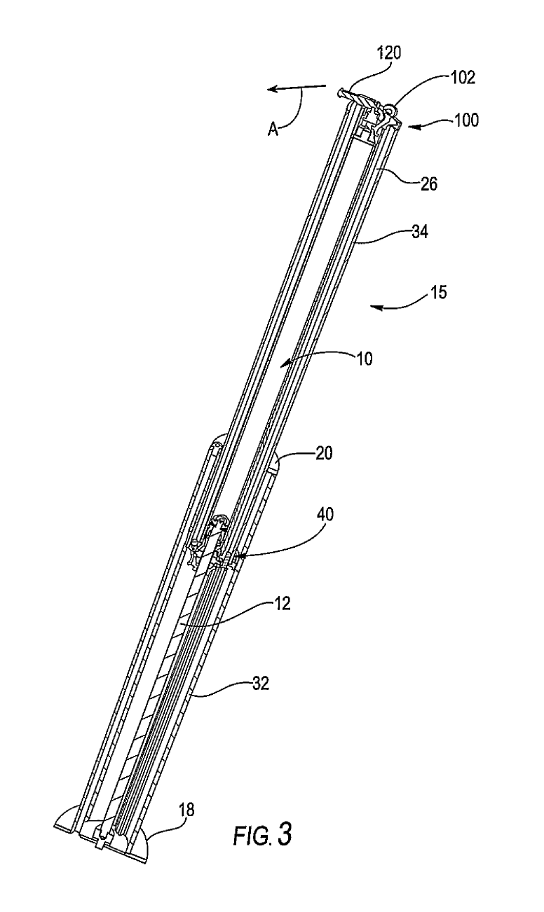

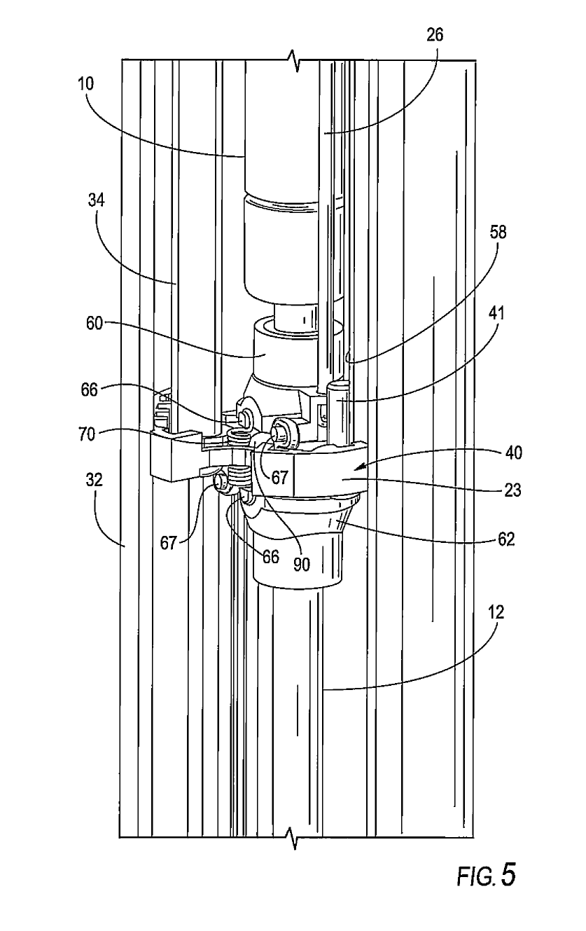

FIG. 1 shows adjustable tables 30 which include a height adjustment assembly including telescopic tubes 32 and 34 extending between a floor support 36 and a table surface 38. FIG. 2 shows one of the table legs 15 with a support flange 35 at the upper end of telescopic tube 34 and a fitting 33 which extends into a socket in the floor support 36 of FIG. 1. The telescopic tube 34 slideably extends within outer tube 32 with polymeric bearings 20 (FIGS. 2) and 23 (FIG. 5) providing smoothly guided movement between the tubes 32, 34. The general construction of leg 15 is disclosed in the above-identified application Ser. No. 61/758,997, entitled SELF-ALIGNING AXIAL BEARING. Within the telescopic tubes, there is a fluid spring, such as gas spring 10 shown in FIG. 3, which controls a cylinder rod 12 to raise and lower the extruded inner table support tube 34. For such purpose, the opposite ends of spring 10 are conventionally coupled to each of the tubes 32, 34 so that extension of rod 12 causes the overall length of the tubes forming the pedestal table leg 15 to extend and retract for raising and lowering the table surface 38. Fixedly coupled to the lower end of extruded tube 34 is the locking mechanism 40 of the present invention. The outer tube 32 is mounted to support a member, such as 33 in FIG. 2 or 18 in FIG. 3. The orientation of the telescopic tubes can be reversed depending upon a particular application.

The leg assembly 15 so-formed also includes a safety release 100 which includes a

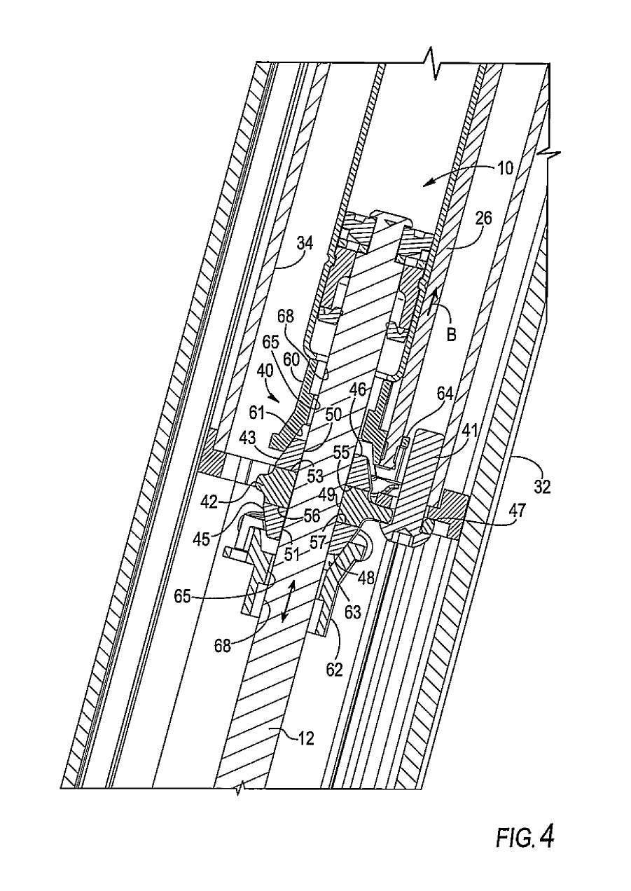

Bowden cable release 120 (FIG. 3) which is coupled to a control handle (not shown) and is limited in its movement, as shown by arrow A, to a few millimeters. A link 102 couples the cable release 120 to a release rod 26, which, when raised in the direction of arrow B in FIG. 4, releases the locking mechanism 40. The safety release 100 is described in greater detail in copending U.S. patent application Ser. No. (Attorney Docket No. SUS001 P344) filed on the even date herewith and entitled SAFETY RELEASE, the disclosure of which is incorporated herein by reference.

The locking mechanism 40, which is secured to one of the telescopic tubes 32, 34, grips the rod 12 extending from gas spring 10 in any desired position selected by the user by moving rod 26 upwardly, as indicated by arrow B, to release the grip on rod 12 by locking mechanism 40. The table surface can then be manually raised or pushed down until the desired position of the table (or chair) is reached.

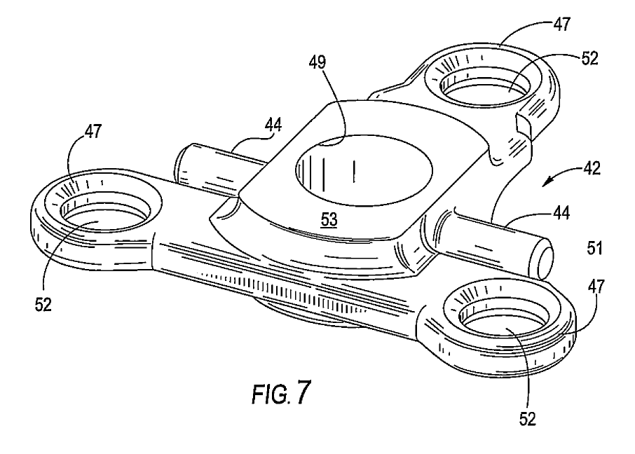

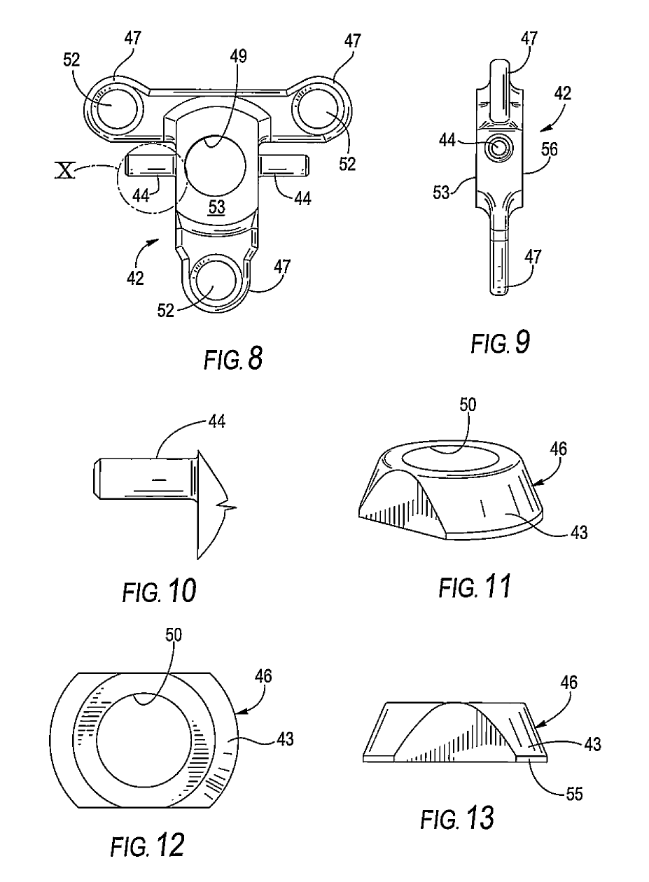

The locking mechanism 40 comprises a lock base 42, which is a generally triangular member having a central aperture 49 (FIGS. 4, 7 and 8) surrounding piston rod 12. It includes three lateral flanges 47 (FIGS. 7 and 8) with apertures 52 through which three screws 41 extend to securely fix the lock base and hence the locking mechanism 40 to threaded extrusions 58 (partially shown in FIG. 5) of the extruded hexagonal inner support tube 34 to secure the locking mechanism to the lower end of tube 34. The outer tube 32 is fixed and is attached to the table (or chair) base, while the inner extruded tube 34 moves up and down with the rod 12 sliding through locking mechanism 40, when in a released position, to raise and lower the table attached to the upper end of extruded tube 34. Associated with the lock base 42 are opposed upper and lower conical cam plates 46, 48 with external conical surfaces 43 and 45 (FIGS. 4 and 11-13). Surfaces 43, 45 are engaged by interior conical mating surfaces 61 and 63 of upper and lower movable clamping members 60 and 62 (FIGS. 4-6, 14, and 15-18), respectively. The plates 46, 48 have central apertures 50, 51 (FIGS. 4, 11, and 12) which generally align with aperture 49 of lock base 42 and receive rod 12, which extends through members 60, 46, 42, 48 and 62, as best seen in FIG. 4. Lock base 42 has an upper surface 53 which is slideably engaged by the lower surface 55 (FIGS. 4, 7, 8, and 13) of conical cam plate 46. Similarly, the lower surface 56 of lock base 42 is engaged by the upper surface 57 of conical cam plate 48. This sliding or floating arrangement of the cam plates 46, 48 allows the tapered clamping members 60, 62 to better engage the offset cam plates to effect locking of the locking member 40 to rod 12, as described below.

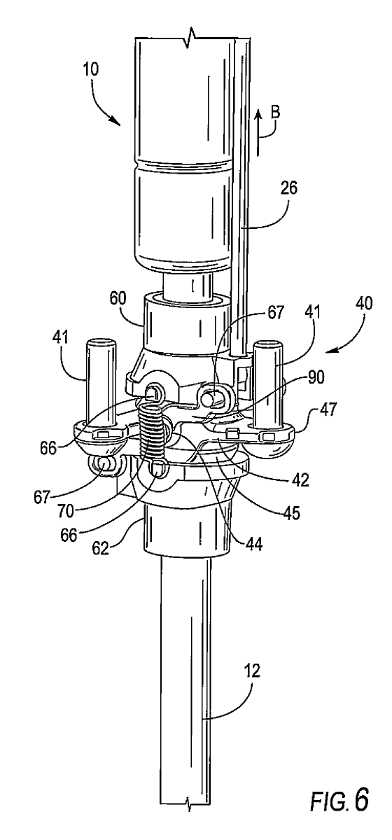

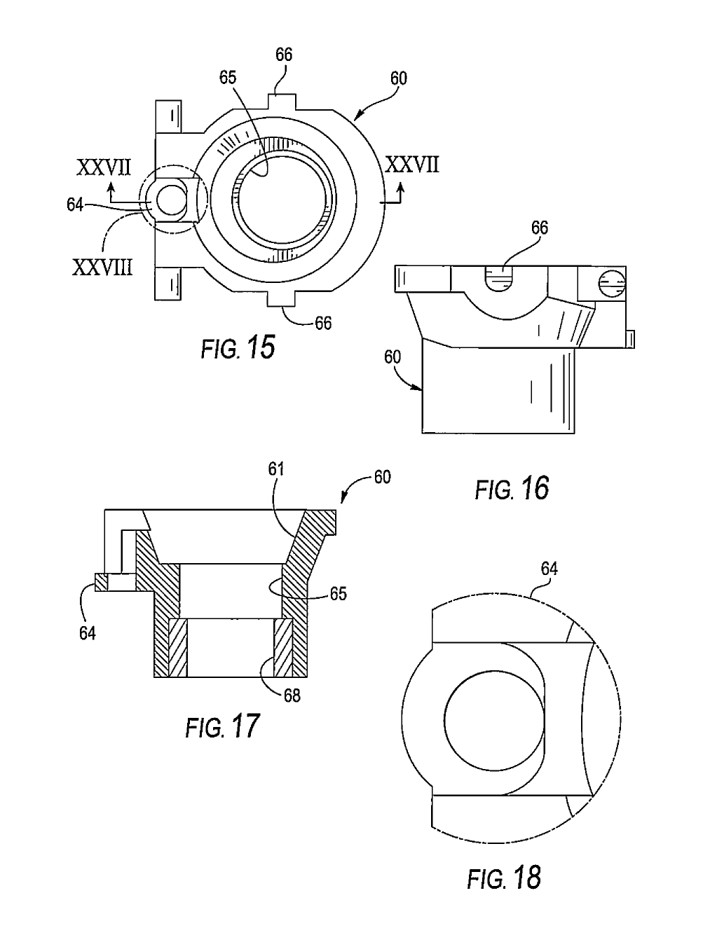

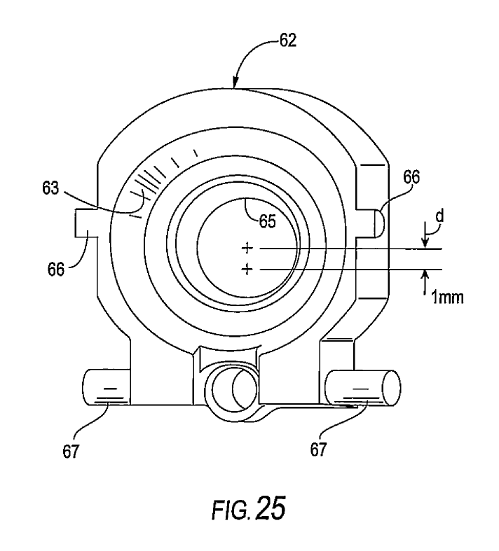

Extension springs 70 (FIGS. 5, 6, 23 and 24) have loop ends 71 which fit over mounting tabs 66 on opposite sides of each of the clamping members 60, 62, as best seen in FIG. 6, to urge members 60, 62 in a compressed position against lock base 42. Members 60, 62 have center apertures 65 (FIGS. 15 and 17) which are offset a distance d (FIG. 25) of about 1 mm from the axis of their conical surfaces 61, 63 and shift and/or tilt members 60, 62 under the forces of springs 70 such that, when compressed to the opposed conical surfaces 43 and 45 of conical cam plates 46, 48, the inner cylindrical surfaces 68 (FIG. 17) of center apertures 65 bind to the outer surface of rod 12, thereby locking the inner extruded tube 34 in a selected adjusted position. Polymeric bearing sleeves 20, 23 (shown in FIGS. 2, 3, and 5) facilitate movement of tubes 32 and 34 when the locking mechanism is unlocked.

The unlocking of mechanism 40 is controlled by rod 26, which is coupled to the bracket 64 of upper clamping member 60, which, along with clamping member 62, has outwardly extending pins 67 on each side (FIGS. 5, 14 and 15). Pins 67 extend through apertures 91 in the ends of pivoted levers 90, which are pivotally mounted to lock base 42 by pivot axles 44 (FIGS. 6-10) integrally extending from opposite sides of the lock base 42. Lateral pressure from springs 70 hold the levers 90 in place on lock base 42, as best seen in FIGS. 5 and 6.

When rod 26 is moved upwardly in the direction of arrow B in FIG. 6, levers 90 rotate in a counterclockwise direction, as viewed in FIG. 6, to raise clamping member 60 away from lock base 42 and associated cam plate 46, as well as pushing clamping member 62 downwardly away from the lock base 42 and associated cam plate 48, thereby allowing the apertures 65 of clamping members to move to a coaxial position around rod 12. This releases the locking force of members 60, 62 against rod 12 and permits the table-supporting extruded tube 34 to move up and down on rod 12 extending or collapsing the telescopic tubes 32, 34. The actual weight of the table on members 60, 62 offset by the force of gas spring 10 causes the apertures 65 of members 60, 62 offset from the central aperture 49 of locking base 42 to increase the effect of the locking action.

The weight on the table surface is transferred by lock base 42 and conical cam plates 46, 48 to one or the other of the clamping members 60, 62 of the locking mechanism. When the weight exceeds the force of spring 10, the lower clamping member 62 locks against the rod 12 as the conical surface 45 of cam plate 48 (FIG. 4) pushes against conical mating surface 63 of clamping member 62. When the weight on the table surface is less than the force of spring 10, lock base 42 wants to raise and conical surface 43 of cam plate 46 engages the conical mating surface 61 of upper clamping member 60 to prevent the undesired raising of the table. Thus, the table surface will remain in a selected adjusted position until such time as the safety release 100 is actuated. The heavier the weight on the table, the more locking force is applied, with the springs 70 positioning locking members 60, 62 into a locking position. By providing members 60 and 62 on opposite sides of the locking base 42, the table is locked against either raising or lowering until the release rod 26 is moved upwardly in the direction of arrow B.

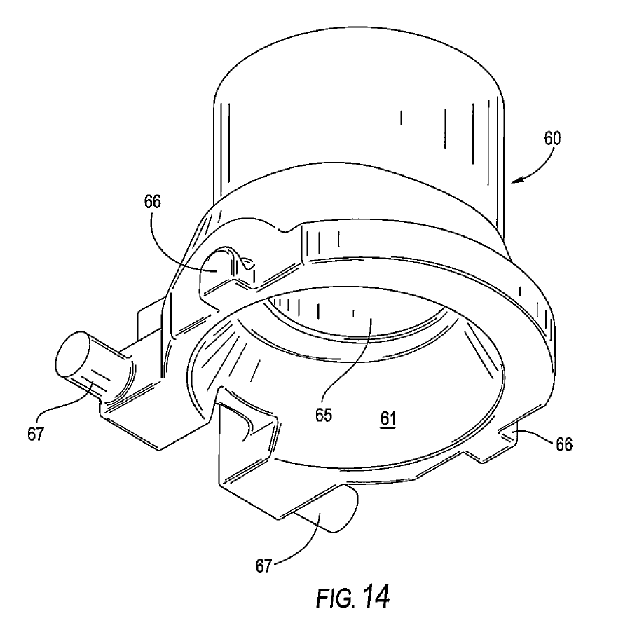

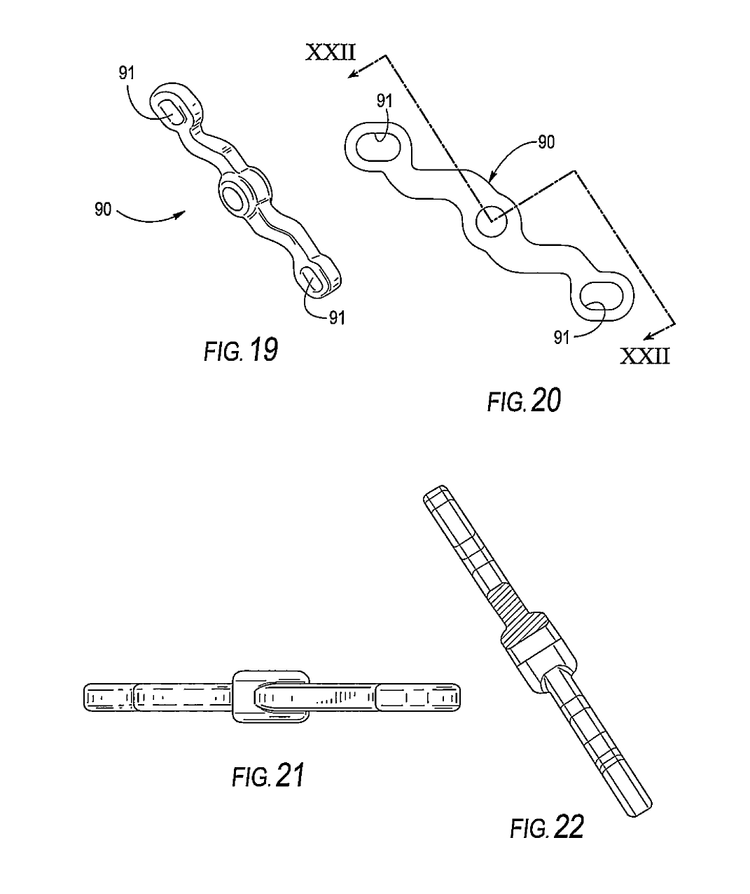

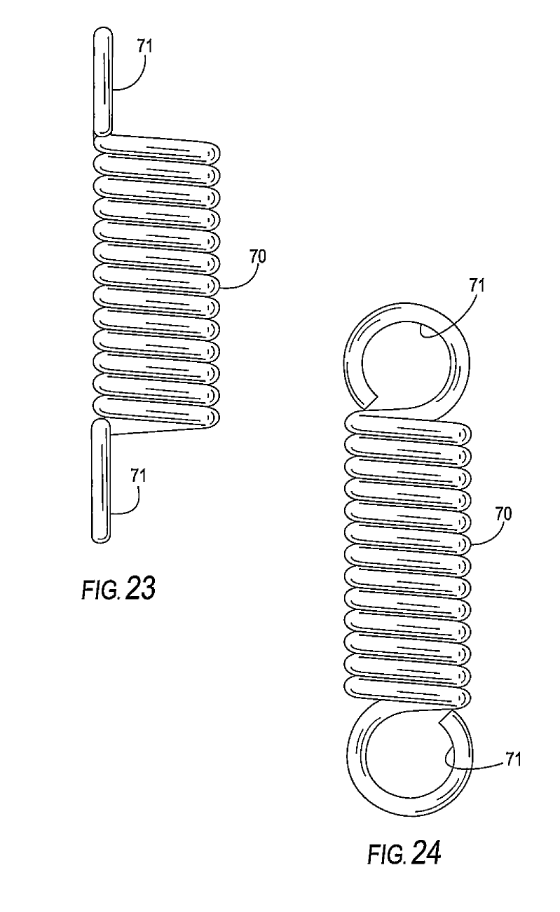

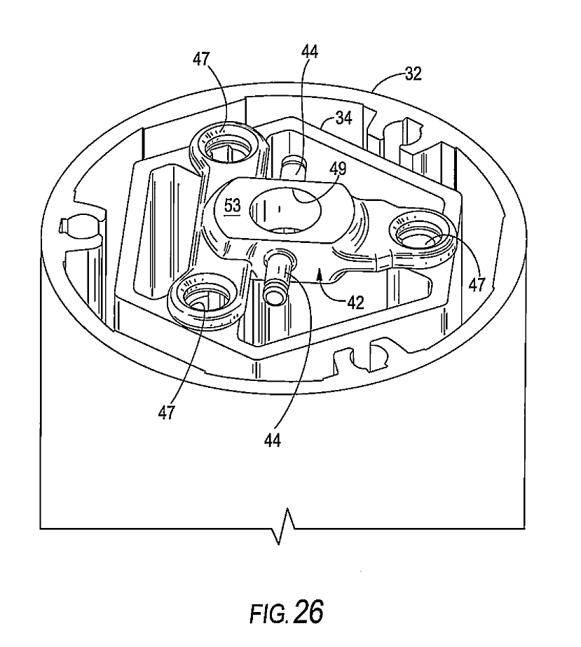

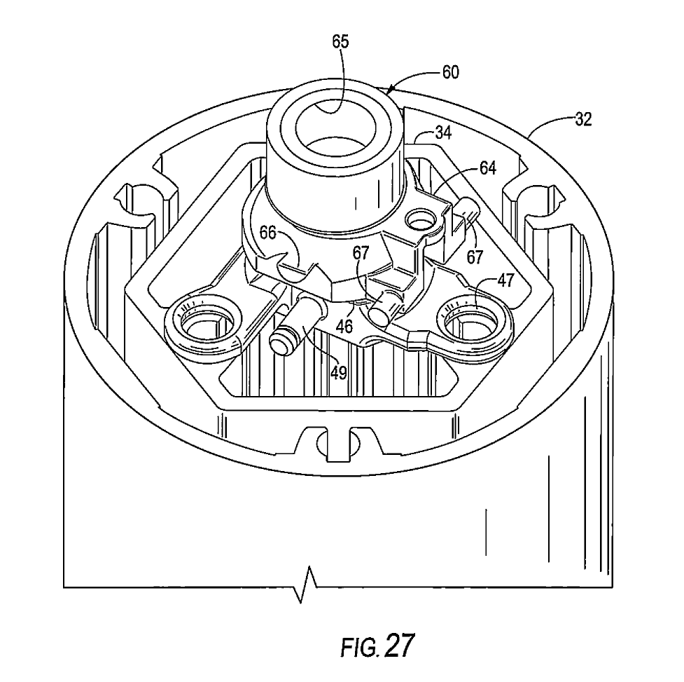

The details of construction of the lock base 42 and cam plates 46, 48 are shown in FIGS. 7-13, while the details of construction of the metal clamping members 60, 62 is shown in FIGS. 14-18. The details of construction of the coupling levers 90 is shown in FIGS. 19-22, while the details of springs 70 are shown in FIGS. 23 and 24. FIG. 6 shows the locking assembly 40 mounted to rod 12. The top plan view of clamping member 62 in FIG. 25 illustrates the 1 mm offset of the axis of the central aperture 65 and the axis of the interior conical surface 63. FIG. 26 illustrates the position of the lock base 42 at the end of inner tube 34, and the drawing of FIG. 27 illustrates the positioning of upper clamping member 60 with respect to lock base 42.

The locking mechanism 40 (FIG. 3) grips the rod 12 extending from gas spring 10 in any desired position selected by the user until it is desired to change the position of the table. In which case, cable release 120 (FIG. 3) is drawn inwardly (to the left in FIG. 3), moving rod 26 upwardly through link 102 to release the grip on rod 12 by locking mechanism 40. Unless overloaded or under loaded, the table can then be lowered or raised under the influence of gas spring 10. The safety release 100 (FIG. 3) prevents the release of the locking mechanism when the table is overloaded, such that it will not precipitously drop. If the weight on the table is significantly less than the force provided by the gas spring, the safety release will also prevent the release of the locking mechanism, such that the table surface will not quickly raise. The operation of the safety release assembly 100 to accomplish these features is disclosed in detail in provisional application entitled SAFETY RELEASE, Ser. No. 61/672,925, filed on Jul. 18, 2012, by Wilkinson et al, and utility application entitled SAFETY RELEASE, Ser. No. (SUS001 P344), filed on the even date herewith, the disclosures of which are incorporated by reference.

It will become apparent to those skilled in the art that various modifications to the preferred embodiment of the invention as described herein can be made without departing from the spirit or scope of the invention as defined by the appended claims.

The invention claimed is:

1. A brake for a fluid cylinder rod comprising:
a lock base having an axially extending central aperture and an associated pair of opposed conical members surrounding said aperture for receiving a rod therethrough;
a pair of clamping members positioned on opposite sides of said lock base, each of said members including a center aperture and a conical surface having an axis offset from the axis of said center aperture; and
a coupling for moving said clamping members into engagement with said conical members associated with said lock base, such that said center apertures of said conical members are offset from said central aperture of said lock base and grip a rod extending therethrough.

2. The brake as defined in claim 1 wherein said coupling includes a pivot pin extending from said lock base and a pivot lever pivotally coupled to said pivot pin and having opposite ends coupled to said clamping members such that as said pivot lever is rotated said clamping members move toward or away from said lock base.

3. The brake as defined in claim 2 and further including a bias spring coupled between said clamping members to urge them into contact with said conical members associated with said lock base.

4. The brake as defined in claim 3 and further including a release rod coupled to one of said clamping members for moving said clamping members away from each other.

5. The brake as defined in claim 4 wherein said lock base includes a pair of opposed pivot pins and said coupling includes a pair of pivot levers coupled to said pivot pins of said lock base and to said clamping members.

6. The brake as defined in claim 5 wherein said clamping members each include pivot pins extending outwardly from opposite sides and said opposite ends of said pivot levers are pivotally coupled to said pivot pins of said clamping members.

7. The brake as defined in claim 1 wherein said associated conical members are a pair of conical cam plates positioned on opposite sides of said lock base.

8. A brake system for an adjustable member comprising:
a pair of telescopic tubes and a gas spring coupled between said tubes for adjusting their length, wherein said gas spring includes an extendable member;
a lock base fixedly secured to one of said tubes and having an axially extending central aperture surrounding said extendable member;
a pair of conical cam plates positioned on opposite sides of said lock base, each with apertures generally aligned with said central aperture;
a pair of clamping members positioned on opposite sides of said lock base and cam plates, each of said members including a center aperture surrounding said extendable member on opposite sides of said lock base and a conical surface having an axis offset from the axis of said center aperture; and
a coupling for moving said clamping members into engagement with said cam plates with the respective conical surfaces in contact such that said center apertures are offset from said central aperture of said lock base and engage said extendable member to prevent its movement.

9. The brake as defined in claim 8 wherein said coupling includes a pivot pin extending from said lock base and a pivot lever pivotally coupled to said pivot pin and having opposite ends coupled to said clamping members such that as said pivot lever is rotated said clamping members move toward or away from said lock base.

10. The brake as defined in claim 9 and further including a bias spring coupled between said clamping members to urge them into contact with said lock base.

11. The brake as defined in claim 10 and further including a release rod coupled to one of said clamping members for moving said clamping members away from each other.

12. The brake as defined in claim 11 wherein said lock base includes a pair of opposed pivot pins and said coupling includes a pair of pivot levers coupled to said pivot pins of said lock base and to said clamping members.

13. The brake as defined in claim 12 wherein said clamping members each include pivot pins extending outwardly from opposite sides and said opposite ends of said pivot levers are pivotally coupled to said pivot pins of said clamping members.

14. A brake for engaging a rod comprising:
a base having an axially extending central aperture;
a pair of plates with conical surfaces and apertures positioned on opposite sides of said base;
a pair of clamping members positioned on opposite sides of said plates, each of said members including a center aperture and a conical surface having an axis offset from the axis of said center aperture;
a rod extending through said apertures in said base, said plates and said clamping members; and
a spring for moving said clamping members into engagement with said plates with the respective conical surfaces in contact such that said center apertures of said clamping members are offset from said central aperture of said base and engage said rod.

15. The brake as defined in claim 14 wherein said base includes a pivot pin and a pivot lever is pivotally coupled to said pivot pin and having opposite ends coupled to said clamping members such that as said pivot lever is rotated said clamping members move toward or away from said base.

16. The brake as defined in claim 15 and further including a release rod coupled to one of said clamping members for moving said clamping members away from each other.

17. The brake as defined in claim 16 wherein said base includes a pair of opposed pivot pins and a pair of pivot levers are coupled to said pivot pins of said base and to said clamping members.

18. The brake as defined in claim 17 wherein said clamping members each include pivot pins extending outwardly from opposite sides and said opposite ends of said pivot levers are pivotally coupled to said pivot pins of said clamping members.

19. The brake as defined in claim 18 wherein said brake is coupled to the rod of a gas spring extending between a pair of telescopic tubes for adjusting their length.

20. The brake as defined in claim 19 and further including a safety release coupled to one of said clamping members to prevent movement of said clamping member when the telescopic tubes have an excessive force on them.
